(19) United States
(12) Patent Application Publication
(10) Pub. No.: US 2026/0257405 A1
(43) Pub. Date: Sep. 3, 2026

(54) METHOD FOR MANUFACTURING CLEANING TOOL WITH SURFACE ROUGHNESS BY CUTTING BUBBLES

(71) Applicant: Yu Jin CHOI, Jeju-si, Jeju-do (KR)

(72) Inventor: Yu Jin CHOI, Jeju-si, Jeju-do (KR)

(21) Appl. No.: 19/162,953

(22) PCT Filed: May 22, 2024
(86) PCT No.: PCT/KR2024/006893

§ 371 Date: Sep. 8, 2025

(30) Foreign Application Priority Data
May 31, 2023 (KR) 10-2023-0069660

(51) Int. Cl. B29C 44/02; B29C 44/34; B29C 44/56; B29L 31/00

(52) U.S. Cl. CPC B29C 44/02; B29C 44/3419; B29C 44/3426; B29C 44/3442; B29C 44/56; B29C 2793/0027; B29C 2793/009; B29L 2031/7406

(57) ABSTRACT

The present invention implements a method for manufacturing a cleaning tool with surface roughness by cutting bubbles, the method enabling the amount of bubbles to be controlled by the whipping speed and time of a konjac mixture kneaded using a konjac powder as a main material, enabling the size of bubbles to be controlled by means of bubble expansion generated through steam heating, enabling excellent cleaning power to be exhibited according to surface roughness by cutting many bubbles, and enabling cleaning tools, to be distinguished by purpose such as for packs, toners, cleansing, puffs and towels, according to pore size or surface roughness, and to provide same.

### TECHNICAL FIELD

The present invention relates to a method for manufacturing a cleaning tool by adjusting the amount of bubbles through the whipping time of a konjac mixture, controlling the size of bubbles based on bubble expansion via steam heating, determining the pore size according to use purposes of pads, puffs, or towels, and cutting the bubbles to classify surface roughness.

### BACKGROUND ART

In general, towels or sponges are used for skin cleansing or washing. Most of such towels or sponges are made of chemically-derived fibrous materials. Moreover, when cotton, cosmetic pads, non-woven fabrics, or other chemically-derived fibrous materials are used for toner application, facial cleansing, or partial massage packs, there are problems such as lint generation, tearing, physical irritation to the skin, or skin side effects. Additionally, the materials also tend to be non-biodegradable, thereby causing environmental pollution.

To cope with such problems, sponge or gauze products made of natural ingredients for skin cleansing or washing have been released. However, sponges have disadvantages in that the volume of the sponge decreases during use, the shape of the sponge is deformed, the sponge remains only superficially moistened without absorption, foam generation of the sponge decreases, and the replacement cycle of the sponge becomes shortened.

As a conventional art, a method for manufacturing a konjac sponge disclosed in Patent Document 1 has a disadvantage in that the method does not control the pore size or the surface roughness of the konjac sponge, and thus the konjac sponge is not differentiated in terms of classification according to use and cleaning power.

### DISCLOSURE

### Technical Problem

Accordingly, the present invention has been made in view of the above-mentioned problems occurring in the related art, and it is an objective of the present invention to manufacture a cleaning tool with the pore size or surface roughness according to use purposes of konjac pads, puffs, or towels by adjusting the amount of bubbles through the whipping time of a konjac mixture containing a foaming agent in a kneader and controlling the size of bubbles based on bubble expansion through steam heating.

### Technical Solution

To accomplish the above-mentioned objects, according to the present invention, there is provided a method for manufacturing a cleaning tool with surface roughness by cutting bubbles, the method including: (a) placing a konjac mixture, in which purified water is mixed at a predetermined ratio with konjac powder having a viscosity of 30,000 to 35,000 mPa·s to which a foaming agent is added, into a kneader, and whipping the mixture at a maximum of 360 rpm for 8 to 10 seconds or at a minimum of 166 rpm for 50 seconds to generate bubbles; (b) feeding the konjac mixture with bubbles generated by whipping into a discharger and placing the konjac mixture into a mold of a predetermined shape and form, and aging the mixture at 5 to 7° C. for 12 to 15 hours; (c) placing the aged mold containing the konjac mixture into a steam heater and heating the mold with steam at a predetermined temperature for 50 to 70 minutes; (d) cooling the mold at room temperature for 3 to 5 hours after steam heating; (e) rapidly freezing the cooled mold at −30° C. for 2 hours in a freezer when the mold containing the konjac mixture is cooled; (f) maintaining the rapidly frozen mold at −7° C. for 24 hours in the freezer after rapidly freezing the mold containing the konjac mixture; (g) thawing the mold for 12 hours; (h) separating the konjac mixture from the thawed mold and then refreezing the mixture at −7° C. for 24 hours; (i) cutting the refrozen konjac mixture using a cutter into a predetermined thickness to form cleaning tools, and classifying the cleaning tools according to surface roughness; (j) freeze-drying the classified cleaning tools at −7° C. for 72 hours in the freezer; (k) taking out the freeze-dried cleaning tools and washing the cleaning tools two to three times; (l) freeze-drying the washed cleaning tools in a freeze dryer for 12 to 18 hours; and (m) sorting and packaging the freeze-dried cleaning tools by use, thickness, or size.

Moreover, the konjac powder and purified water are mixed at a ratio of 1:16, and the purified water is prepared by mixing water and purified water at a ratio of 1:20.

Furthermore, for a pad for packs as a cleaning tool, the konjac mixture is whipped at 360 rpm for 8 to 10 seconds and then at 166 rpm for 50 seconds, for a pad for toners as a cleaning tool, the konjac mixture is whipped at 360 rpm for 15 to 18 seconds and then at 166 rpm for 50 seconds, and for cleansing pads, puffs, or towels as cleaning tools, the konjac mixture is whipped at 360 rpm for 20 to 25 seconds and then at 166 rpm for 50 seconds.

Additionally, when the mold containing the konjac mixture is steam-heated by a steam heater, for a pad for packs as a cleaning tool, the thickness is 0.5 to 1 mm, the bubble diameter is 0.3 to 0.8 mm, and the heating temperature is 80 to 90° C., for a pad for toners as a cleaning tool, the thickness is 1.2 to 1.5 mm, the bubble diameter is 1.0 to 1.3 mm, and the heating temperature is 90 to 100° C., for a cleansing pad as a cleaning tool, the thickness is 2.0 to 3.0 mm, the bubble diameter is 1.5 to 2.0 mm, and the heating temperature is 100 to 110° C., for a cleansing puff as a cleaning tool, the thickness is 5.0 to 15.0 mm, the bubble diameter is 1.5 to 3.0 mm, and the heating temperature is 100 to 110° C., and for a cleansing towel as a cleaning tool, the thickness is 5.0 to 8.0 mm, the bubble diameter is 1.5 to 3.0 mm, and the heating temperature is 100 to 110° C.

In addition, the mold is formed in a cylindrical or polygonal column shape.

### Advantageous Effect

The method for manufacturing a cleaning tool with surface roughness by cutting bubbles according to the present invention can adjust the amount of bubbles by the whipping speed and time of the konjac mixture kneaded using konjac powder as a main material, control the size of the bubbles by bubble expansion generated through steam heating, and exhibit excellent cleaning power by cutting the numerous bubbles according to the surface roughness. The cleaning tools can be categorized and provided according to pore size or surface roughness, by various purposes such as for packs, toners, cleansing, puffs, and towels, thereby preventing issues such as lint generation, tearing, physical irritation, or side effects to the skin, which may occur when using conventional products made of cotton, cosmetic pads, non-woven fabric, or chemical materials for toner application, face washing, or partial massage packs. The cleaning tool manufactured by the manufacturing method can provide several times more functional solution to the skin than conventional cotton products, because toner, essence, or the like is filled into the bubble-cut surfaces formed according to the intended use of a konjac pad, unlike conventional products in which the solution is merely absorbed onto the surface of cotton or non-woven fabric, thereby achieving superior effects compared to the conventional cotton products. In addition, the surface roughness formed by cutting the bubbles (pores) of cleansing konjac pads, puffs, and towels provides excellent cleaning power, thereby removing wastes and keratin without irritating the skin and improving the skin condition.

### DESCRIPTION OF DRAWINGS

FIG. 1 is a flowchart illustrating a method for manufacturing a cleaning tool with surface roughness by cutting bubbles according to an embodiment of the present invention.

FIGS. 2A and 2B are schematic views showing a mold for manufacturing a cleaning tool with surface roughness by cutting bubbles according to the present invention.

FIGS. 3A and 3B are product photographs showing a cleaning tool manufactured by the method for manufacturing a cleaning tool with surface roughness by cutting bubbles according to the present invention.

FIGS. 4A and 4B are photographs illustrating a konjac mixture, separated from a mold, being cut into a predetermined thickness using a cutter in the method for manufacturing a cleaning tool with surface roughness by cutting bubbles in accordance with the present invention.

FIGS. 5A and 5B are magnified photographs showing the surface of the cleaning tool manufactured by the method for manufacturing a cleaning tool with surface roughness by cutting bubbles according to the present invention.

### BEST MODE

The present invention relates to a method for manufacturing a cleaning tool by adjusting the amount of bubbles through the whipping time of a konjac mixture, controlling the size of bubbles based on bubble expansion via steam heating, determining the pore size according to use purposes of pads, puffs, or towels, and cutting the bubbles to classify surface roughness. The method for manufacturing a cleaning tool with surface roughness by cutting bubbles includes: (a) placing a konjac mixture, in which purified water is mixed at a predetermined ratio with konjac powder having a viscosity of 30,000 to 35,000 mPa·s to which a foaming agent is added, into a kneader, and whipping the mixture at a maximum of 360 rpm for 8 to 10 seconds or at a minimum of 166 rpm for 50 seconds to generate bubbles; (b) feeding the konjac mixture with bubbles generated by whipping into a discharger and placing the konjac mixture into a mold of a predetermined shape and form, and aging the mixture at 5 to 7° C. for 12 to 15 hours; (c) placing the aged mold containing the konjac mixture into a steam heater and heating the mold with steam at a predetermined temperature for 50 to 70 minutes; (d) cooling the mold at room temperature for 3 to 5 hours after steam heating; (e) rapidly freezing the cooled mold at −30° C. for 2 hours in a freezer when the mold containing the konjac mixture is cooled; (f) maintaining the rapidly frozen mold at −7° C. for 24 hours in the freezer after rapidly freezing the mold containing the konjac mixture; (g) thawing the mold for 12 hours; (h) separating the konjac mixture from the thawed mold and then refreezing the mixture at −7° C. for 24 hours; (i) cutting the refrozen konjac mixture using a cutter into a predetermined thickness to form cleaning tools, and classifying the cleaning tools according to surface roughness; (j) freeze-drying the classified cleaning tools at −7° C. for 72 hours in the freezer; (k) taking out the freeze-dried cleaning tools and washing the cleaning tools two to three times; (l) freeze-drying the washed cleaning tools in a freeze dryer for 12 to 18 hours; and (m) sorting and packaging the freeze-dried cleaning tools by use, thickness, or size.

### MODE FOR INVENTION

Hereinafter, a method for manufacturing a cleaning tool with surface roughness by cutting bubbles according to the present invention will be described in detail.

The present invention relates to manufacturing pads, puffs, or towels for packs, toners, or cleansing using plant-based materials primarily composed of konjac. Konjac is Amorphophallus konjac of the Araceae family plant, and the tuber of konjac consists of 75 to 83% moisture, 11 to 14% carbohydrates, and 2 to 4.5% protein. The main component of konjac flour is mannan, which is a polysaccharide. The sugar, also referred to as konjac mannan, is contained in specific cells of parenchymal tissue. A concentrated extract of konjac mannan is referred to as refined flour whose main component is glucomannan. About 99% of the carbohydrate content of konjac consists of glucomannan. Glucomannan is a sugar composed of mannose and glucose, both of which are hexoses.

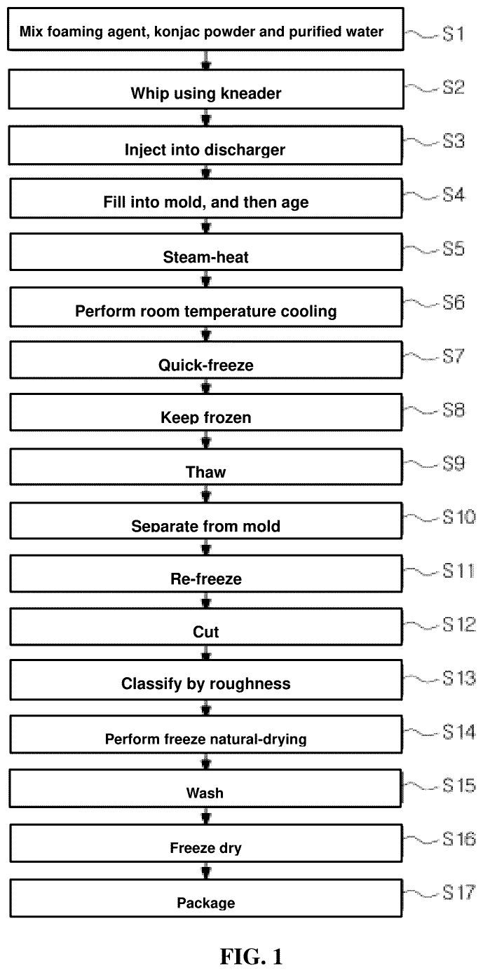

Next, an embodiment will be described with reference to the flowchart illustrating the method for manufacturing a cleaning tool with surface roughness by cutting bubbles, as shown in FIG. 1.

### Embodiment

Konjac powder having a viscosity of 30,000 mPa·s or more to which a foaming agent is added is mixed with purified water at a predetermined ratio (S1). In this case, the konjac powder and purified water are mixed at a ratio of 1:16. The foaming agent may be added in an amount of 0.2 to 0.3% by weight relative to the total mixture. Moreover, regular water and the purified water are mixed at a ratio of 1:20. It is preferable that the viscosity of the konjac powder is in the range of 30,000 to 35,000 mPa·s. In addition, dyes and mordants may be added to the mixture to produce konjac pads in various colors.

The konjac mixture, in which the foaming agent, the konjac powder, and the purified water are mixed, is placed into a kneader and whipped to generate bubbles (S2). The whipped konjac mixture contains fine bubbles, and the high viscosity of the konjac powder helps maintain the formed fine bubbles without collapse. At this time, whipping blades in the kneader may rotate at a maximum speed of approximately 360 rpm for about 8 to 10 seconds, or at a minimum speed of approximately 166 rpm for about 50 seconds. Furthermore, the whipping blades in the kneader may be operated by switching between the maximum speed and the minimum speed or gradually decreasing from the maximum speed to the minimum speed during whipping.

When manufacturing a pad for packs as a cleaning tool by whipping the konjac mixture in the kneader, the mixture may be whipped at 360 rpm for approximately 8 to 10 seconds and then whipped at 166 rpm for approximately 50 seconds. When manufacturing a pad for toners as a cleaning tool by whipping the konjac mixture, the konjac mixture may be whipped at 360 rpm for approximately 15 to 18 seconds and then whipped at 166 rpm for approximately 50 seconds. Additionally, when manufacturing pads, puffs or towels for cleansing as cleaning tools, the konjac mixture may be whipped at 360 rpm for approximately 20 to 25 seconds and then whipped at 166 rpm for approximately 50 seconds.

Next, the kneaded mixture containing bubbles, formed by adjusting the rotation speed and time of whipping in the kneader, is introduced into a discharger (S3). Thereafter, the kneaded mixture is poured into a plurality of molds having predetermined shapes, forms, and volumes, and then, is aged at a temperature of approximately 5 to 7° C. for about 12 to 15 hours (S4). In this case, if the aging temperature of the konjac mixture exceeds approximately 7° C., the fully formed konjac mixture may not be cleanly separated from the molds. Furthermore, the aging time of the konjac mixture should be maintained for at least around 12 hours in order to ensure consistent quality in the final products such as pads, puffs, and towels used as cleaning tools.

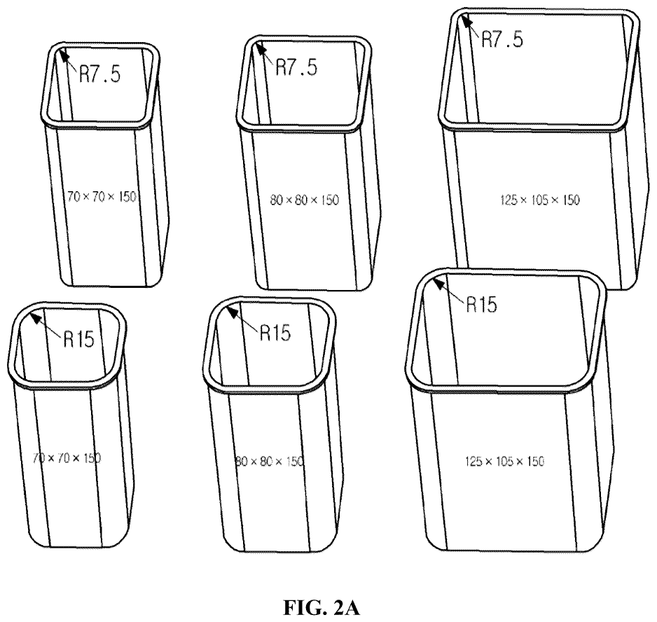

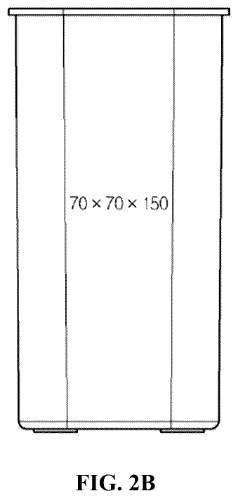

In FIG. 2A, various sizes and volumes of molds are schematically illustrated. Each mold may be a container with an open top, having a cylindrical or polygonal column shape. As illustrated in FIG. 2B, the upper edge of the mold preferably includes a flange protruding to function as a handle. Additionally, a handle may be formed on the side of the mold, and a plurality of support legs may be provided at the bottom of the mold. In addition, if the mold is in the shape of a rectangular column, it is preferable that the corners are rounded in an arc shape. Furthermore, the mold may be configured with separate openings for the injection and ejection of the konjac mixture. It is preferable that the mold is made of a material capable of maintaining its shape and structure even when exposed to a predetermined temperature range.

Once the aging process is completed, the mold is placed into a steam heater, and is exposed to steam at a set temperature and heated for approximately 50 to 70 minutes, preferably about 60 minutes (S5). In this instance, the steam heating temperature to heat the mold may vary depending on the type of product being manufactured. For example, when producing pads for packs, the thickness is approximately 0.5 to 1 mm, the bubble diameter is approximately 0.3 to 0.8 mm, and the heating temperature is approximately 80 to 90° C. Moreover, in case of steam heating of the steam heater, for pads for toners, the thickness is approximately 1.2 to 1.5 mm, the bubble diameter is approximately 1.0 to 1.3 mm, and the steam heating temperature is approximately 90 to 100° C. Additionally, for cleansing pads, the thickness is approximately 2.0 to 3.0 mm, the bubble diameter is approximately 1.5 to 2.0 mm, and the steam heating temperature is approximately 100 to 110° C. For cleansing puffs as cleaning tools, the thickness is approximately 5.0 to 15.0 mm, the bubble diameter is approximately 1.5 to 3.0 mm, and the steam heating temperature is approximately 100 to 110° C. For cleansing towels as cleaning tools, the thickness is approximately 5.0 to 8.0 mm, the bubble diameter is approximately 1.5 to 3.0 mm, and the steam heating temperature is approximately 100 to 110° C.

Once the steam heating of the konjac mixture introduced into the mold is completed by the steam heater, the steam-heated mold is cooled at room temperature for approximately 3 to 5 hours (S6).

Then, the cooled mold is placed in a freezer and rapidly frozen at approximately −30° C. for about 2 hours (S7). The rapidly frozen mold is then maintained in the freezer at approximately −7° C. for about 24 hours (S8). Subsequently, the frozen mold is taken out and thawed for approximately 12 hours (S9). After thawing for a predetermined period of time, the konjac mixture is separated from the mold (S10) and refrozen in the freezer at approximately −7° C. for about 24 hours (S11).

Thereafter, the frozen konjac mixture is cut using a cutter into cleaning tools of predetermined thicknesses, such as konjac pads, puffs, and towels (S12). For example, as cleaning tools, pads for packs are cut to a thickness of approximately 0.5 to 1 mm, pads for toners are cut to approximately 1.2 to 1.5 mm, cleansing pads are cut to approximately 2.0 to 3.0 mm, cleansing puffs are cut to approximately 5.0 to 15.0 mm, and cleansing towels are cut to approximately 5.0 to 8.0 mm. Moreover, the cut cleaning tools are then classified according to surface roughness into konjac pads, puffs, or towels (S13). The classified cleaning tools such as konjac pads, puffs, or towels are placed into the freezer and dried in a frozen state at approximately −7° C. for approximately 72 hours (S14). The freeze-drying of the cleaning tools is to strengthen the dietary fiber structure of konjac, making it tougher and more durable.

Furthermore, after the freeze-drying in the freezer for approximately 72 hours to allow natural evaporation of moisture, the freeze-dried cleaning tools such as konjac pads, puffs, and towels are taken out and washed approximately two or three times (S15). The washed cleaning tools are then placed into a freeze dryer and subjected to a freeze-drying process for approximately 12 to 18 hours (S16).

Afterwards, the freeze-dried cleaning tools such as konjac pads, puffs, and towels are sorted according to use, thickness, or size, and packaged with corresponding packaging materials (S17).

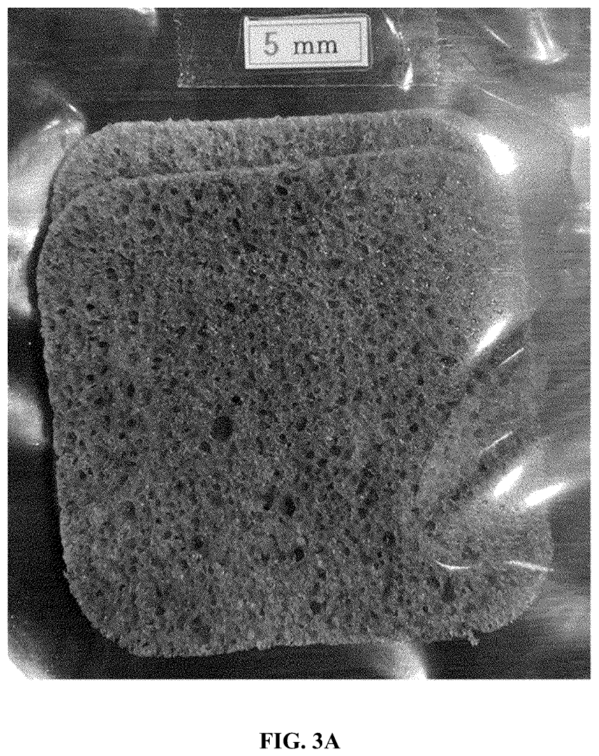

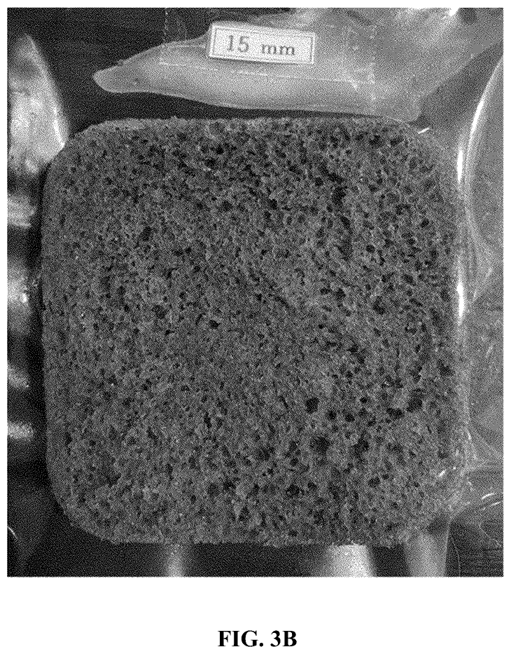

FIGS. 3A and 3B are product photographs showing the cleaning tools, namely konjac pads and puffs manufactured according to the manufacturing method of the present invention. FIG. 3A shows the surface of a konjac pad manufactured to a thickness of 5 mm, and FIG. 3B shows the surface of a konjac puff manufactured to a thickness of 15 mm. The surface has roughness formed in accordance with the size of the pores.

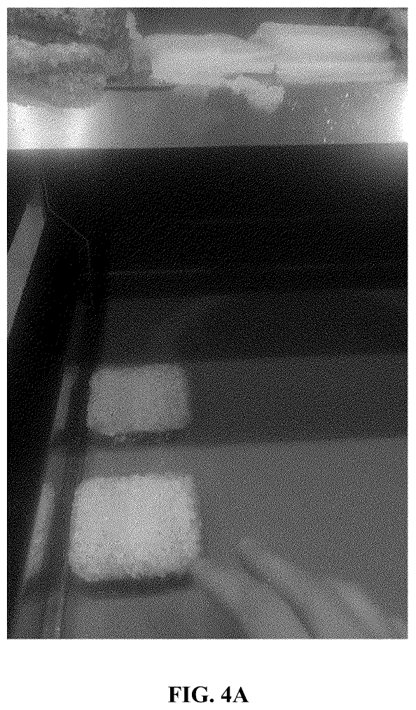

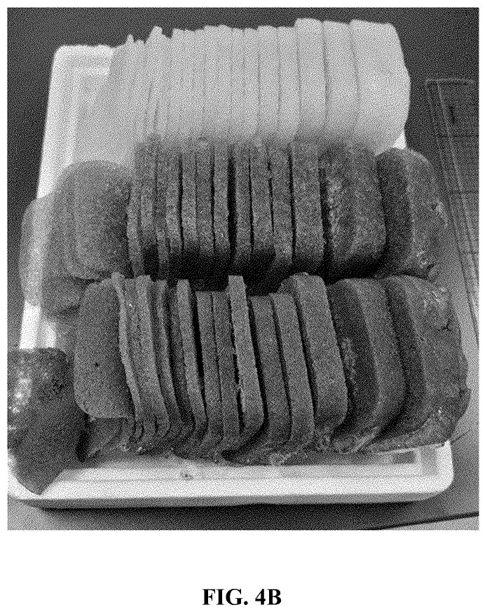

FIG. 4A is a photograph showing the konjac mixture, separated from the mold, being cut into a predetermined thickness using a cutter. FIG. 4B shows konjac pads and puffs cut into various thicknesses, and also illustrates pads and puffs dyed in various colors.

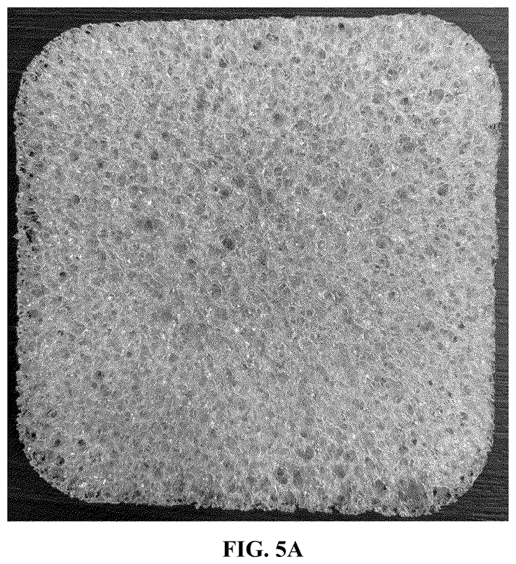

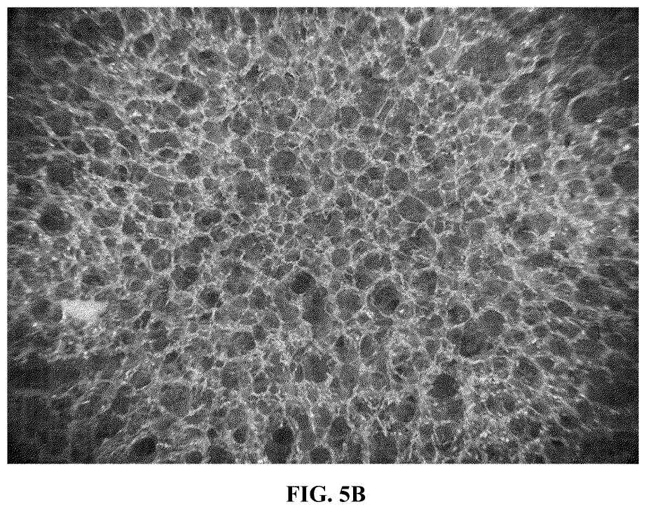

FIG. 5A shows the surface of a konjac pad manufactured using the method of the present invention, and FIG. 5B is a magnified photograph of the surface of the konjac pad, showing that a plurality of pores are formed on the surface.

The cleaning tools such as konjac pads, puffs, and towels manufactured according to the present invention can adjust the amount of bubbles by the whipping speed and time of the kneaded konjac mixture, control the size of the bubbles by bubble expansion generated through steam heating, and exhibit excellent cleaning power by cutting the numerous bubbles according to the surface roughness.

The embodiments described in the present invention are merely examples, and the present invention is not limited thereto. Any configuration that is substantially the same as the technical idea described in the claims of the present invention and achieves the same effects shall be construed as falling within the technical scope of the present invention.

### INDUSTRIAL APPLICABILITY

The method for manufacturing a cleaning tool with surface roughness by cutting bubbles according to the present invention can adjust the amount of bubbles by the whipping speed and time of the konjac mixture kneaded using konjac powder as a main material, control the size of the bubbles by bubble expansion generated through steam heating, and exhibit excellent cleaning power by cutting the numerous bubbles according to the surface roughness. The cleaning tools can be categorized and provided according to pore size or surface roughness, by various purposes such as for packs, toners, cleansing, puffs, and towels, thereby preventing issues such as lint generation, tearing, physical irritation, or side effects to the skin, which may occur when using conventional products made of cotton, cosmetic pads, non-woven fabric, or chemical materials for toner application, face washing, or partial massage packs. The cleaning tool manufactured by the manufacturing method can provide several times more functional solution to the skin than conventional cotton products, because toner, essence, or the like is filled into the bubble-cut surfaces formed according to the intended use of a konjac pad, unlike conventional products in which the solution is merely absorbed onto the surface of cotton or non-woven fabric, thereby achieving superior effects compared to the conventional cotton products. In addition, the surface roughness formed by cutting the bubbles (pores) of cleansing konjac pads, puffs, and towels provides excellent cleaning power, thereby removing wastes and keratin without irritating the skin and improving the skin condition.

1. A method for manufacturing a cleaning tool with surface roughness by cutting bubbles, the method comprising:
(a) placing a konjac mixture, in which purified water is mixed at a predetermined ratio with konjac powder having a viscosity of 30,000 to 35,000 mPa·s to which a foaming agent is added, into a kneader, and whipping the mixture at a maximum of 360 rpm for 8 to 10 seconds or at a minimum of 166 rpm for 50 seconds to generate bubbles;
(b) feeding the konjac mixture with bubbles generated by whipping into a discharger and placing the konjac mixture into a mold of a predetermined shape and form, and aging the mixture at 5 to 7° C. for 12 to 15 hours;
(c) placing the aged mold containing the konjac mixture into a steam heater and heating the mold with steam at a predetermined temperature for 50 to 70 minutes;
(d) cooling the mold at room temperature for 3 to 5 hours after steam heating;
(e) rapidly freezing the cooled mold at −30° C. for 2 hours in a freezer when the mold containing the konjac mixture is cooled;
(f) maintaining the rapidly frozen mold at −7° C. for 24 hours in the freezer after rapidly freezing the mold containing the konjac mixture;
(g) thawing the mold for 12 hours;
(h) separating the konjac mixture from the thawed mold and then refreezing the mixture at −7° C. for 24 hours;
(i) cutting the refrozen konjac mixture using a cutter into a predetermined thickness to form cleaning tools, and classifying the cleaning tools according to surface roughness;
(j) freeze-drying the classified cleaning tools at −7° C. for 72 hours in the freezer;
(k) taking out the freeze-dried cleaning tools and washing the cleaning tools two to three times;
(l) freeze-drying the washed cleaning tools in a freeze dryer for 12 to 18 hours; and
(m) sorting and packaging the freeze-dried cleaning tools by use, thickness, or size.

2. The method according to claim 1, wherein the konjac powder and purified water are mixed at a ratio of 1:16, and the purified water is prepared by mixing water and purified water at a ratio of 1:20.

3. The method according to claim 1, wherein for a pad for packs as a cleaning tool, the konjac mixture is whipped at 360 rpm for 8 to 10 seconds and then at 166 rpm for 50 seconds, for a pad for toners as a cleaning tool, the konjac mixture is whipped at 360 rpm for 15 to 18 seconds and then at 166 rpm for 50 seconds, and for cleansing pads, puffs, or towels as cleaning tools, the konjac mixture is whipped at 360 rpm for 20 to 25 seconds and then at 166 rpm for 50 seconds.

4. The method according to claim 1, wherein when the mold containing the konjac mixture is steam-heated by a steam heater, for a pad for packs as a cleaning tool, the thickness is 0.5 to 1 mm, the bubble diameter is 0.3 to 0.8 mm, and the heating temperature is 80 to 90° C.,
for a pad for toners as a cleaning tool, the thickness is 1.2 to 1.5 mm, the bubble diameter is 1.0 to 1.3 mm, and the heating temperature is 90 to 100° C.,
for a cleansing pad as a cleaning tool, the thickness is 2.0 to 3.0 mm, the bubble diameter is 1.5 to 2.0 mm, and the heating temperature is 100 to 110° C.,
for a cleansing puff as a cleaning tool, the thickness is 5.0 to 15.0 mm, the bubble diameter is 1.5 to 3.0 mm, and the heating temperature is 100 to 110° C., and
for a cleansing towel as a cleaning tool, the thickness is 5.0 to 8.0 mm, the bubble diameter is 1.5 to 3.0 mm, and the heating temperature is 100 to 110°C.

5. The method according to claim wherein the mold is formed in a cylindrical or polygonal column shape.
